(19) United States
(12) Patent Application Publication
(10) Pub. No.: US 2012/0138018 A1
(43) Pub. Date: Jun. 7, 2012

(54) METHOD FOR OPERATING AN INTERNAL COMBUSTION ENGINE SUITABLE FOR OPERATION WITH GASEOUS AND LIQUID FUELS

(76) Inventor: Klaus Wunderlich, Waiblingen (DE)

(21) Appl. No.: 13/349,151

(22) Filed: Jan. 12, 2012

Related U.S. Application Data
(63) Continuation-in-part of application No. PCT/EP2010/003689, filed on Jun. 18, 2010.

(30) Foreign Application Priority Data
Jul. 16, 2009 (DE) 10 2009 033 861.6

(51) Int. Cl. F02D 41/06

(52) U.S. Cl. 123/445

(57) ABSTRACT

In a method for operating an internal combustion engine designed for operation with gaseous or liquid fuel, wherein gaseous fuel is introduced into an intake duct upstream of a combustion chamber of the internal combustion engine and liquid fuel is directly injected into the combustion chamber, the internal combustion engine is operated in a start-stop mode, wherein for starting the engine liquid fuel is injected into the combustion chamber of at least one cylinder so as to start the engine after shut-down with the first compression stroke of the internal combustion engine whereupon gaseous fuel is introduced into the intake duct for the second and all following engine strokes.

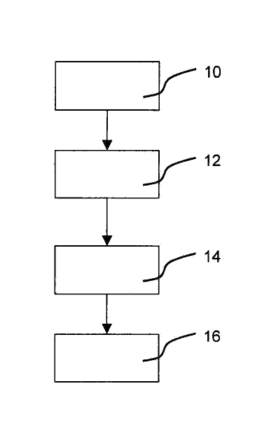

This is a Continuation-In-Part application of pending international patent application PCT/EP2010/003689 filed Jun. 18, 2010 and claiming the priority of German patent application 10 2009 033 861.6 filed Jul. 16, 2009.

### BACKGROUND OF THE INVENTION

The invention relates to a method for operating an internal combustion engine for gaseous and liquid fuels, wherein the gaseous fuel is introduced into an engine intake duct upstream of a combustion chambers of the internal combustion engine. When the internal combustion engine is operated with the liquid fuel, the liquid fuel is directly injected into the combustion chambers of the engine.

DE 10 2006 049 242 A1 relates to an internal combustion engine which can be operated with gaseous and liquid fuel. For this purpose, an induction pipe of the internal combustion engine is fitted with at least one fuel injector for each cylinder, by means of which natural gas can be blown into the induction duct of each cylinder. Each cylinder of the internal combustion engine is further provided with a liquid fuel injector, by means of which liquid fuel can be injected directly into the combustion chamber. By operating the internal combustion engine with natural gas, comparatively low emissions can be achieved.

It is the object of the present invention to provide an improved method of operating an internal combustion engine designed for operation with gaseous or liquid fuels.

### SUMMARY OF THE INVENTION

In a method for operating an internal combustion engine designed for operation with gaseous or liquid fuel, wherein gaseous fuel is introduced into an intake duct upstream of a combustion chamber of the internal combustion engine and liquid fuel is directly injected into the combustion chamber, the internal combustion engine is operated in a start-stop mode, wherein for starting the engine liquid fuel is injected into the combustion chamber of at least one cylinder so as to start the engine after shut-down with the first compression stroke of the internal combustion engine whereupon gaseous fuel is introduced into the intake duct for the second and all following engine strokes.

The start-stop mode results in a reduction of the fuel consumption of the internal combustion engine and therefore in particularly low emissions, in particular in lower carbon dioxide emissions. In the start-stop mode, the internal combustion engine is switched off when drive power is not required. This provides an improved method for operating an internal combustion engine for gaseous and liquid fuels. The liquid fuel may be in particular a gasoline-type fuel.

In a particular embodiment of the invention, the liquid fuel is injected into the combustion chamber of at least one cylinder if a stop of the internal combustion engine is followed by a start in the start-stop mode. This is based on the finding that the direct introduction of gaseous fuel into the combustion chamber in the start-stop mode results in a reduced starting comfort. This is due to the fact that, if gaseous fuel is introduced into the intake train when a stop of the internal combustion engine is followed by a start, at least one intake stroke is required before ignition in order to supply the air/gas mixture to the combustion chamber.

In contrast, in an internal combustion engine with direct injection of liquid fuel, the fuel is injected directly into a combustion chamber which is already filled with air. Following the stop of the internal combustion engine, a piston of a cylinder is preferably in the region of bottom dead center. When starting, only a compression stroke is required before the first ignition in the cylinder occurs if liquid fuel is injected into the cylinder. This allows in the internal combustion engine for gaseous and liquid fuel for a particularly fast and efficient start following a shut-down of the internal combustion engine.

This provides accordingly for a fast start-up of the internal combustion engine, as it is common in an internal combustion engine which injects liquid fuel directly into the combustion chambers of internal combustion engines. In addition, the liquid fuel in the injector is regularly replaced if the stop of the internal combustion engine is followed by a start, even if the internal combustion engine is basically operated with a gaseous fuel, for example compressed natural gas (CNG). This further allows for a periodic functional check and diagnosis of the direct injection system for liquid fuel.

It has further been found to be advantageous if, when a stop of the internal combustion engine is followed by a start in the start-stop mode, gaseous fuel is introduced into the intake duct of the cylinder during an induction stroke following a single injection of liquid fuel into the combustion chamber of at least one cylinder. This means that liquid fuel is preferably injected only once, and then the respective cylinder is once again operated with gaseous fuel after starting. As the internal combustion engine is already at operating temperature at a start following a stop in the start-stop mode, no wall film formation is to be expected in the injection of liquid fuel, so that the injection of liquid fuel is accompanied by good emission values.

According to a further aspect of the invention, an improved internal combustion engine for gaseous and liquid fuel, which comprises at least one gas injector by means of which gaseous fuel can be introduced into an intake duct upstream of a combustion chamber of the internal combustion engine, and which comprises at least one further injector by means of which liquid fuel can be directly introduced into the combustion chamber, includes a control unit for a start-stop mode.

Preferred embodiments of the invention will be described below for the method according to the invention on the basis of the accompanying drawing.

### BRIEF DESCRIPTION OF THE DRAWING

The sole FIGURE shows a flow chart for the operation of an internal combustion engine for gaseous and liquid fuel.

### DESCRIPTION OF PARTICULAR EMBODIMENTS

An internal combustion engine (not shown in the drawing) for a motor vehicle can be operated with gaseous and liquid fuel, for example compressed natural gas (CNG) and gasoline. For the introduction of the gas into an intake duct, the internal combustion engine is provided with a gas injector. There is further provided a liquid fuel injector by means of which liquid fuel is directly injected into the combustion chamber of each cylinder. The internal combustion engine comprises a control unit for a start-stop mode of operation.

In the start-stop mode, a stop 10, for example at a traffic light or a railway crossing, is followed by an injection 12 of liquid fuel into the combustion chamber of a least one cylinder of the internal combustion engine. The combustion chamber is filled with air at this stage. Due to the preceding stop 10, the piston of the cylinder is in the area of the bottom dead center before the compression stroke. The starter effects a compression stroke of the piston and a compression of the air in the combustion chamber, followed by liquid fuel injection into the combustion chamber and an ignition 14 of the fuel/air mixture in the combustion chamber.

After starting with liquid fuel injection, the cylinder switches over 16 to operation with gas. This means that gas operation is established during or after the start-up phase of the internal combustion engine.

The switch-over 16 from liquid fuel to gas is already possible if liquid fuel has been injected into only one cylinder of an internal combustion engine which has several cylinders.

As an alternative, a single liquid fuel injection 12 into a plurality or, in particular, into all cylinders can be provided before a switch-over 16 from liquid fuel operation to gas operation.

Also, more than a single liquid fuel injection 12 can be provided for each cylinder. In this case, the switch-over 16 only happens after liquid fuel has been injected into the respective cylinder in more than one work cycle.

The switch-over 16 may further be a continuous process, so that a decreasing amount of liquid fuel is directly injected into a cylinder while an increasing amount of gas is introduced into the intake duct, i.e. the fuel switch-over is carried out in a ramped manner.

The switch-over 16 from liquid fuel to gaseous fuel may also be performed as a function of an operating temperature of the internal combustion engine, i.e. when the internal combustion engine has reached a certain minimum operating temperature.

It may further be provided that no liquid fuel is injected when starting after a stop 10 and that instead gaseous fuel is introduced into the intake duct instead if the internal combustion engine is still cold and there is a risk that an undesirable fuel film might form on the cylinder walls if liquid fuel is used as a fuel, or if no liquid fuel is available.

What is claimed is:

1. A method for operating an internal combustion engine which is operable selectively by gaseous and liquid fuel, wherein the gaseous fuel is introduced into an intake duct upstream of a combustion chamber of the internal combustion engine and wherein the liquid fuel is directly injected into the combustion chamber, said method comprising the steps of, for operating the engine in the gaseous fuel operating mode, first injecting liquid fuel into the combustion chamber of at least one cylinder for engine start-up with the first compression stroke and subsequently introducing the gaseous fuel into the intake duct of the cylinder in a subsequent induction stroke, thereby providing, in the start-stop mode operation, after an engine shut-down, for instant start-up of the internal combustion engine.

2. The method according to claim 1, wherein the gaseous fuel is introduced into the intake duct of the cylinder if a stop (12) of the internal combustion engine is followed by a start in the start-stop mode, after the liquid fuel has been injected once into each of the respective combustion chambers of an engine having a plurality of cylinders.

3. The method according to claim 1, wherein a decreasing amount of liquid fuel is injected into the cylinder while, at the same time, an increasing amount of gaseous fuel is introduced into the intake duct if a stop (12) of the internal combustion engine is followed by a start in the start-stop operating mode of the engine.

4. The method according to claim 1, wherein, in the start-stop engine operating mode, after a stop, a switch-over (16) from liquid fuel to gaseous fuel or from gaseous fuel to liquid fuel is carried out as a function of a temperature of the internal combustion engine.
